(19) United States
(12) Patent Application Publication
(10) Pub. No.: US 2006/0010763 A1
(43) Pub. Date: Jan. 19, 2006

(54) Electronic fishing lure

(75) Inventors: Christopher Sung Min Podlewski, Williamsville, NY (US); Michael Dean Armbruster, Buffalo, NY (US)

Correspondence Address: C. Paul Maliszewski, P.E.;Simpson & Simpson, PLLC, 5555 Main Street, Williamsville, NY, 14221-5406, US

(73) Assignee: Bikini Lures, Inc., Buffalo, NY (US)

(21) Appl. No.: 10/890,416

(22) Filed: Jul. 13, 2004

(51) Int. Cl. A01K 85/01

(52) U.S. Cl. 43/17.6; 43/42.31

(57) ABSTRACT

The present invention broadly comprises an electronic fishing lure, including a programmable microcontroller, a digital switch to control said microcontroller, a constant current, constant voltage recharge circuit with a lithium-ion rechargeable battery, a plurality of light-emitting diodes (LEDs), and an audio output device. The LEDs and audio device are connected to the microcontroller and the microcontroller activates the lights and audio device according to a software program stored in the microcontroller.

### REFERENCE TO COMPUTER PROGRAM LISTING/TABLE APPENDIX

The present application includes a computer program listing appendix on compact disc. Two duplicate compact discs are provided herewith. Each compact disc contains a plurality of files of the computer program listing as follows:

Converted to ASCII Files:

| Name | Size | Created |
|---|---|---|
| Lure Code V11asm.txt | 23 KB | 06/29/2004 |
| Lure Code V11Hex.txt | 4 KB | 06/29/2004 |

The computer program listing appendix is hereby expressly incorporated by reference in the present application.

### FIELD OF THE INVENTION

This invention relates to fishing lures containing electronic circuitry. More specifically it relates to a fishing lure controlling lights and sound devices using control firmware in an on-board microcontroller. Even more particularly, it relates to a programmable fishing lure with a constant voltage, constant current recharging circuit.

### BACKGROUND OF THE INVENTION

Fishing lures employing lights and speakers are known in the art. In the simplest lures, lights and speaker are manually toggled between energized and unenergized states, for example, by a switch on the lure. That is, the lure remains in the selected state until the switch is manually manipulated to activate the opposing state. In other lures, the lights and speakers are controlled using simple timing circuits. For example, a timer circuit can provide a preset time period for energizing the lights or speakers, pulses at a predetermined rate for energizing the lights, or a predetermined oscillation for speakers. That is, the lights blink at a predetermined rate and the speaker emits a signal at a predetermined frequency. However, it is desirable to vary the frequency to make the lure more attractive to game fish and to adapt the lure to varying conditions. Unfortunately, the time period, pulses, and oscillation noted above are all determined by the hardware parameters of the timer circuit and cannot be changed without changing the hardware parameters. Therefore, to change the time period, pulses, and oscillation, it would be necessary to open the lure and replace the timer circuit or elements of the timing circuit.

It also is desirable to blink lights and energize a speaker in varying patterns while the fishing lure is in operation in the water. For example, blinking the lights at a series of successive frequencies that could be in the form of well-defined pattern or in a pseudo-random pattern. Unfortunately, as noted above, the hardware-based control systems noted above are not capable of producing varying patterns while the lure is in use.

Extending battery life and maintaining battery performance, for example, the number of times a battery can be recharged, in a fishing lure are other ongoing concerns. One important factor affecting battery life and performance is the magnitude of the current drain on the battery. In general, for a same total load, increasing the magnitude of the load current reduces battery life and diminishes battery performance. For example, the current associated with two, one watt (W) lamps simultaneously energized for thirty seconds has a greater impact on battery life and performance than the current associated with energizing each lamp for a consecutive 30 second interval, since the magnitude of the current is greater in the first case. However, to present the most attractive visual enticement for a game fish, it is desirable to increase the number of lights used in a lure. Unfortunately, as noted above, increasing the number of lights increases current draw and subsequently reduces battery life and performance. Therefore, the number of lights that can be used in a lure is constrained by battery life and performance considerations.

The use of rechargeable batteries in a fishing lure that can be recharged while on-board the lure has been proposed. However, the batteries proposed have been nickel metal-hydride (NiMh), nickel-cadmium (NiCad), and zinc oxide. These types of batteries are relatively bulky, which is a problem when trying to fit them in a properly sized fishing lure. Also, the relatively primitive recharging circuits proposed for the above fishing lures limit the type of power supply that can be used to recharge the batteries.

Thus, there has been a longfelt need for a programmable fishing lure able to execute more complex control of lights and speakers, powered by more compact and efficient rechargeable batteries, and including an on-board battery charging circuit.

### SUMMARY OF THE INVENTION

In one aspect, the present invention broadly comprises an electronic fishing lure, including a programmable microcontroller, a digital switch to control said microcontroller, a constant current, constant voltage recharge circuit with a lithium-ion rechargeable battery, a plurality of light-emitting diodes (LEDs), and an audio output device. The LEDs and audio device are connected to the microcontroller and the microcontroller activates the lights and audio device according to a software program stored in the microcontroller. The present invention also includes a method for attracting fishing using a fishing lure with a programmable microcontroller.

A general object of the present invention is to provide a fishing lure able to operate onboard lights and audio devices in more complex patterns.

Another object of the present invention is to provide a fishing lure with a rechargeable power supply having an increased charge capacity and an external means for recharging the power supply, and able to accept a wider range of recharging power voltage and current.

A further object of the present invention is to provide a fishing lure with a low-power means for activating programmable circuitry in the lure when the lure is in the water.

Still anther object of the present invention is to provide a fishing lure able to download control software from an external computer.

A still further another object of the present invention is to provide a fishing lure able to provide sophisticated light and sound patterns from a large array of lights and audio devices while minimizing current drain on an on-board battery.

These and other objects, features and advantages of the present invention will become readily apparent to those having ordinary skill in the art upon a reading of the following detailed description of the invention in view of the drawings and claims.

### BRIEF DESCRIPTION OF THE DRAWINGS

The nature and mode of operation of the present invention will now be more fully described in the following detailed description of the invention taken with the accompanying drawing Figures in which:

FIG. 1 is a perspective view showing external features of a present invention fishing lure;

FIG. 2 is a block diagram of a present invention electronic fishing lure;

FIG. 3 is a schematic diagram of a present invention electronic fishing lure;

FIG. 4 is a cross-section view of the lure in FIG. 1, taken along lines 4-4;

FIG. 5 is a pictorial representation of the PCBs shown in FIG. 4; and,

FIGS. 6a and 6b are programming flow charts for a present invention apparatus or method.

### DETAILED DESCRIPTION OF THE INVENTION

At the outset, it should be appreciated that like drawing numbers on different drawing views identify substantially identical structural elements of the invention. While the present invention is described with respect to what is presently considered to be the preferred aspects, it is understood that the invention is not limited to the disclosed aspects.

Furthermore, it is understood that this invention is not limited to the particular methodology, materials and modifications described and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the preferred methods, devices, and materials are now described.

This and other objects, features and advantages of the present invention will become readily apparent to those having ordinary skill in the art upon a reading of the following detailed description of the invention in view of the drawings and claims.

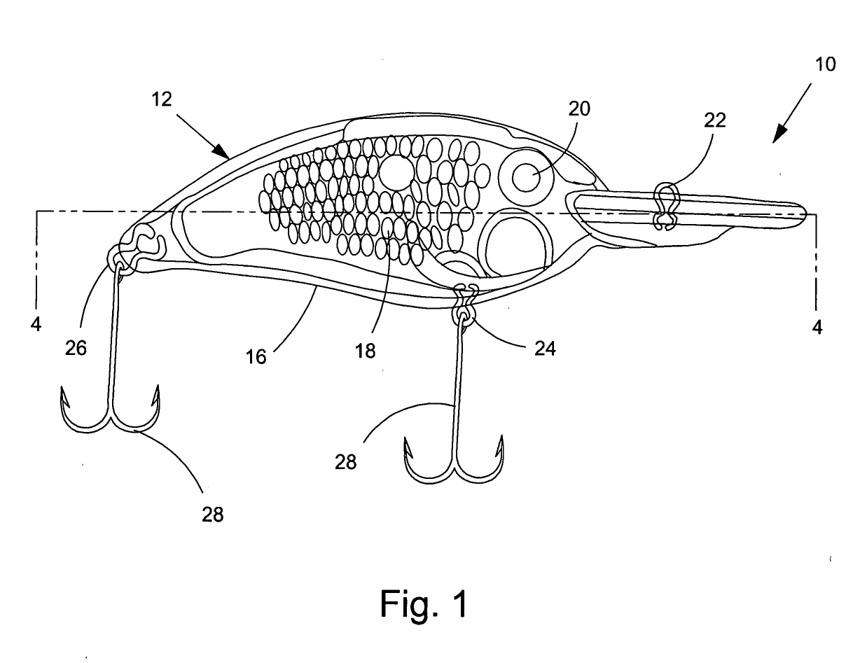

FIG. 1 is a perspective view showing external features of a present invention fishing lure 10. Lure 10 includes a housing 12. Housing 12 can be in any shape known in the art and it should be understood that the present invention is not restricted to any particular shape. In one aspect, housing 12 is formed from a transparent or translucent material so as to allow lights (not shown), positioned within housing 12 to be visible outside the housing. Portions of housing 12 also may be formed from opaque material. Transparent and translucent materials may be clear (colorless) or tinted in various colors. Opaque materials can be of any color known in the art. It also should be understood that lure 10 can be any combination of transparent, translucent, opaque, clear, tinted, or colored materials. Housing 12 may be formed of any material known in the art, such as plastic. Surface 16 of lure 10 also may be scribed or configured, for example, to represent attributes considered attractive to game fish. In FIG. 1, surface 16 is configured to form scales 18 and eye 20. Lure 10 includes head fastener 22, belly fastener 24, and tail fastener 26. Attached to fasteners 24 and 26 are hooks 28. It should be readily apparent to one skilled in the art that other combinations and configurations of fasteners and hooks are possible, and such modifications are within the spirit and scope of the invention as claimed. In some aspects, fasteners 22, 24, and 26 perform other functions as described below.

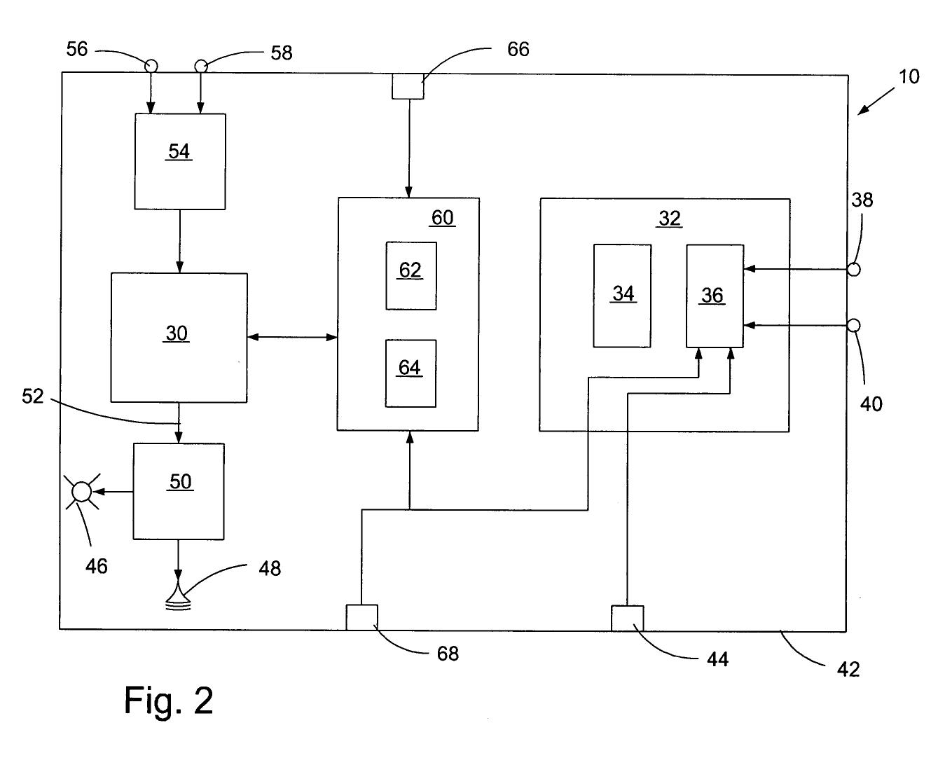

FIG. 2 is a block diagram of a present invention electronic fishing lure 10. Lure 10 includes electronic control element 30 and rechargeable power element 32. Power-recharging element 32 includes rechargeable battery cell 34 and circuitry 36 connected to cell 34. Cell 34 can include a single battery cell or multiple battery cells. Further details regarding cell 34 are provided in the figures that follow. Element 32 also includes recharge contact points 38 and 40, on external surface 42, connected to element 36. Contact points 38 and 40 are used to connect element 32 to an external power supply (not shown). The external power supply, in turn, provides power to recharge cell 34. In some aspects, the contact points are fasteners on surface 42, for example, fasteners 22 and 26.

In some aspects, lure 10 includes a secondary inductor universal serial bus (USB) port 44 connected to power-recharging element 32. Port 44 can be used to interface lure 10 with an external device (not shown) capable of supplying power to element 32. A primary inductor USB port transfers power and/or signal data to a secondary inductor USB port using inductance (i.e., electro-magnetic energy), rather than a mechanical connection of male and female parts (for example pins). That is, the primary and secondary USB ports are placed in close proximity, but do not need to be in physical contact. Therefore, port 44 can be located inside lure 10 and a primary inductor USB port (not shown) can be placed on or near surface 42 to transfer power to port 44. By placing port 44 inside lure 10, the port is protected from the effects of water and other corrosive agents. Placing port 44 inside lure 10 also avoids the necessity of creating an opening in surface 42 which would require a seal and would present a possible avenue for water and other contaminants to enter lure 10.

Lure 10 includes sensory output devices to produce visual and/or audio stimuli attractive to game fish. In general, the sensory output devices are light sources or audio output devices. Lure 10 can include only a light source(s), only audio output device(s), or a combination of light source(s) and audio output device(s), connected to control element 30. In some aspects, a light source is a light-emitting diode (LED). In some aspects, the LED is a variable-voltage (LED). That is, the light spectrum emitted by the LED is dependent on the voltage impressed upon the LED. An audio device is typically a speaker or a buzzer. However, any audio device known in the art may be used in lure 10. In FIG. 2, light 46 and audio device 48 are shown. It should be understood that other combinations and numbers of lights and audio devices are possible for the claimed invention, and such modifications are within the spirit and scope of the invention as claimed. The function and control of the lights sources and audio devices are further explained below. In some aspects, lure 10 includes multiplexing element 50, connected to element 30 and some or all of the sensory output devices in lure 10. In FIG. 2, element 50 interfaces a single output for element 30 on line 52 with light 46 and device 48. The multiplexing element enables a single output from control element 30 to control multiple light sources or audio devices. FIG. 2 shows one simple multiplexing configuration. However, it should be understood that other configurations are possible for the claimed invention, and such modifications are within the spirit and scope of the invention as claimed. Further examples of multiplexing are shown below.

In some aspects, lure 10 includes switch 54 connected to control element 30 and to contact points 56 and 58 located on surface 42. In some aspects, the contact points are fasteners on surface 42, for example, fasteners 24 and 26 shown in FIG. 1. Switch 54 is used to activate element 30. Switch 54 senses one resistance level when contact points 56 and 58 are exposed to air (or a material having a conductance equal to the conductance of air) and another resistance level when the contact points are exposed to water. In response to the first resistance, the switch deactivates element 30. In response to the second resistance, the switch activates element 30. The interaction of switch 54 and element 30 is further explained in the figures that follow.

In some aspects, control element 30 includes timer circuits, oscillator circuits, or combinations of hardware components, such as solid-state components (not shown). In other aspects, element 30 is a programmable microcontroller (not shown). In some aspects, the microcontroller has an arithmetic logic unit (ALU). Other aspects of the microcontroller can include multiplexers and status registers.

In some aspect, lure 10 includes a memory element 60 connected to control element 30. Memory element 60 can be a separate component as shown in FIG. 2 or can be integral to control element 30 (not shown). In some aspects, the memory element includes a non-volatile memory element 62 and a volatile memory element 64. In some aspects, non-volatile memory element 62 is a read-only memory (ROM) element selected from the group including erasable ROM (EPROM) elements, electrically erasable ROM (EEPROM) elements, and FLASH memory elements. In some aspects element 64 is a volatile static RAM with a capacity of 64 bytes. In some aspects, element 62 is a flash memory chip. In some aspects, element 30 is a programmable microcontroller and elements 62 and 64 are integral to the programmable microcontroller (not shown). The memory element, in combination with control element 30, forms the framework for executing the control and operational functions described below.

Control programs in firmware and software, included in the computer program listing appendix, is stored in memory element 60. The programs can be factory-installed in the microcontroller. In some aspects, lure 10 includes secondary inductor USB port 66 connected to memory element 60. Port 66 can be used to download control programs from a remote device (not shown) to memory element 60. In some aspects, the programs are available on a storage medium, such as a compact disc, which can be loaded on a personal computer (PC) and downloaded from the PC to lure 10 using port 66. In some aspects, the programs on the PC can be modified by the user. In some aspects, secondary inductor USB port 68 can be configured to accept both power input for power-recharging element 32 and downloads for memory element 60. The operation of ports 66 and 68 are similar to that described for port 44 above.

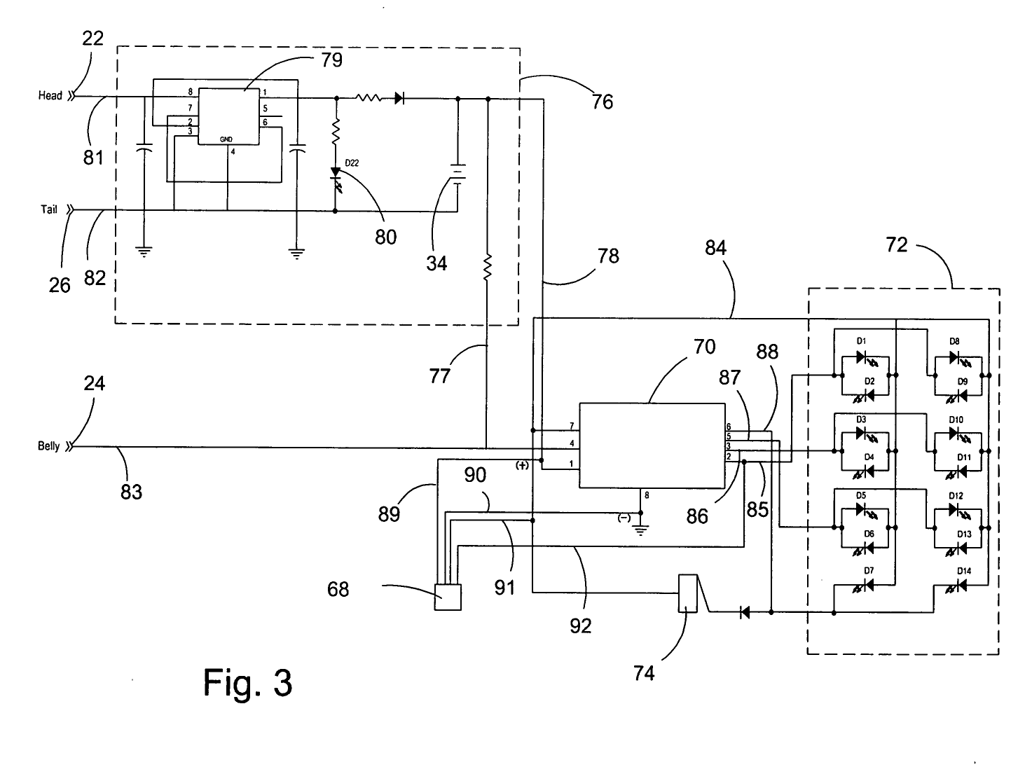

FIG. 3 is a schematic diagram of a present invention electronic fishing lure. The following should be viewed in light of FIGS. 1 through 3. In FIG. 3, control element 30 and memory element 32 are included in programmable microcontroller 70. In some aspects, microcontroller 70 is a complimentary metal oxide semiconductor (CMOS) device. In the aspect shown, microcontroller 70 is a Microchip model PIC12F629. However, it should be understood that the present invention is not restricted to any particular microcontroller and that a wide variety of microcontrollers known in the art are usable in the present invention. Light-emitting diodes (LEDs) 72 and buzzer 74 are connected to microcontroller 70. In FIG. 3, most of the LEDs are configured in pairs, for example, D1 and D2. As described below, microcontroller 70 controls each of the respective pairs as a unit. It should be understood that other configurations of LEDs and buzzers are within the spirit and scope of the invention as claimed.

In some aspects, element 32 is constant voltage, constant current power (CVCC) circuit 76. Circuit 76 is connected to microcontroller 70 on line 78 and ground. FIG. 3 shows one possible configuration for circuit 76. However, it should be readily apparent to one skilled in the art that other configurations are possible, and such modifications are within the spirit and scope of the invention as claimed. A CVCC circuit can accept power with a voltage and/or current rating outside of the input voltage and current parameters for a rechargeable device connected to the circuit. Then, the CVCC circuit can supply recharge power, compliant with the input parameters, to the device. That is, a CVCC circuit accepts a relatively wide range of input voltages and current and supplies a recharging voltage in a relatively narrow range. Hence, a CVCC circuit can effectively charge a battery while protecting the battery from damage. In contrast, typical recharging circuits (not shown), for example, trickle charge circuits, can accept only a relatively narrow range of input voltages and currents. If the input voltage is too low, a device connected to the circuit may not be effectively charged, for example, a 2V input voltage will provide limited charging of a 5.2V battery. If the input voltage and/or current are too high, the battery may be overcharged, damaging circuitry and/or the battery. In a CVCC circuit, charging current is typically allowed to increase up to a predetermined maximum and then held at that maximum until the input voltage returns zero volts.

Circuit 76 includes regulator 79, which performs the self-regulating functions described above. However, it should be understood that other devices and circuit configurations can be used to provide the self-regulating function, and such modifications are within the spirit and scope of the invention as claimed. In the aspect shown, circuit 76 accepts a voltage between approximately 3.4V and 60V and supplies a constant voltage, constant current charge of 3V to rechargeable cell 34. Hence, a wide variety of power sources, such as batteries in a car, motorcycle, or boat, can be used to recharge lure 10. However, it should be understood that circuit 76 can be configured to accept other ranges of input voltages, and such modifications are within the spirit and scope of the invention as claimed. LED 80 in circuit 76 is illuminated when contact points 22 and 26 are connected to a recharge power source compliant with the requirements of circuit 76 and battery 34. Head connector 22 and tail connector 26 act as the contact points for the recharging circuit. The head connector is connected to pin 8 of regulator 70 on line 81 and the tail connector is connected to the ground of regulator 79 on line 82.

In FIG. 3, battery 34 is a lithium-ion cell. It should be understood that battery 34 can include more than one lithium-ion cell. Lithium-ion batteries have a higher energy density than most other types of rechargeable batteries. Thus, for their size or weight lithium-ion batteries can store more energy than other rechargeable batteries. They also operate at higher voltages than other rechargeable batteries, typically about 3.7 volts for lithium-ion vs. 1.2 volts for nickel metal-hydride (NiMH) or nickel cadmium (NiCd). This means a single lithium-ion cell can often be used rather than multiple NiMh or NiCd cells. Lithium-ion batteries also have a lower self-discharge rate than other types of rechargeable batteries. This means that once they are charged they will retain their charge for a longer time than other types of rechargeable batteries. In contrast, NiMH and NiCd batteries can lose anywhere from 1-5% of their charge per day, (depending on the storage temperature) even if they are not installed in a device. Lithium-ion batteries will retain most of their charge even after months of storage. However, it also should be understood that any type of rechargeable battery known in the art, for example, NiMH and NiCd, can be used as battery 34, and such modifications are within the spirit and scope of the invention as claimed.

In some aspects, switch 54 is a digital switch. For example, the switch is a transistor configuration (not shown). Another example is shown in FIG. 3, in which switch 54 (not shown) is integral to microcontroller 70. Belly connector 24 and tail 26 act as the contact points for the switch. The belly connector is connected to pin 4 of microcontroller 70 on line 83. The tail connector provides a reference point and is connected to the ground of regulator 79 on line 82. When lure 10 is out of water, microcontroller 70 enters a low-power, “stand-by” mode in response to a signal from switch 54. In this case, the lure is not in use and by entering the stand-by mode, virtually all power-consuming operations, for example, activating the LEDs, are suspended. Hence, the life of the charge on battery 34 is maximized. When lure 10 is in the water, microcontroller 70 enters an active, operational mode in response to a signal from switch 54, and the microcontroller executes appropriate operations, such as activating the LEDs.

The control over microcontroller 70 operations afforded by switch 54 is applicable to recharging operations as well. For example, in some aspects, battery 34 is a lithium cell. Simultaneously recharging and tapping a lithium cell results in deterioration of battery performance and capacity. Therefore, it is desirable to insure that battery 34 does not simultaneously accept recharge power and provide power to microcontroller 70. Typically, lure 10 is recharged after removal from the water. Switch 54 puts microcontroller in the standby mode when lure 10 is removed from the water, therefore, virtually eliminating the load on the battery and creating an ideal, unloaded state for recharging battery 54.

The non-volatile memory in microcontroller 70 is used to store programs for controlling LEDs 72 and buzzer 74 in a variety of relatively sophisticated command sequences. Microcontroller 70 executes these sequences using built-in multiplexing capabilities (that is, unit 70 incorporates the multiplexing function illustrated by multiplexing element 50 in FIG. 2) and by software time division of tasks. In some aspects, the control programs are firmware written in Assembly language. In some aspects, microcontroller 70 is timer driven, that is, it uses timer interrupts. In some aspects, microcontroller 70 activates LEDs 72 and buzzer 74 according to pattern Lookup data stored in non-volatile memory element 62. By entering the stand/by mode described above, microcontroller 70 also facilitates the operation of circuit 79. That is, in the stand/by mode, lure 10 is in the optimal mode for receiving recharging power.

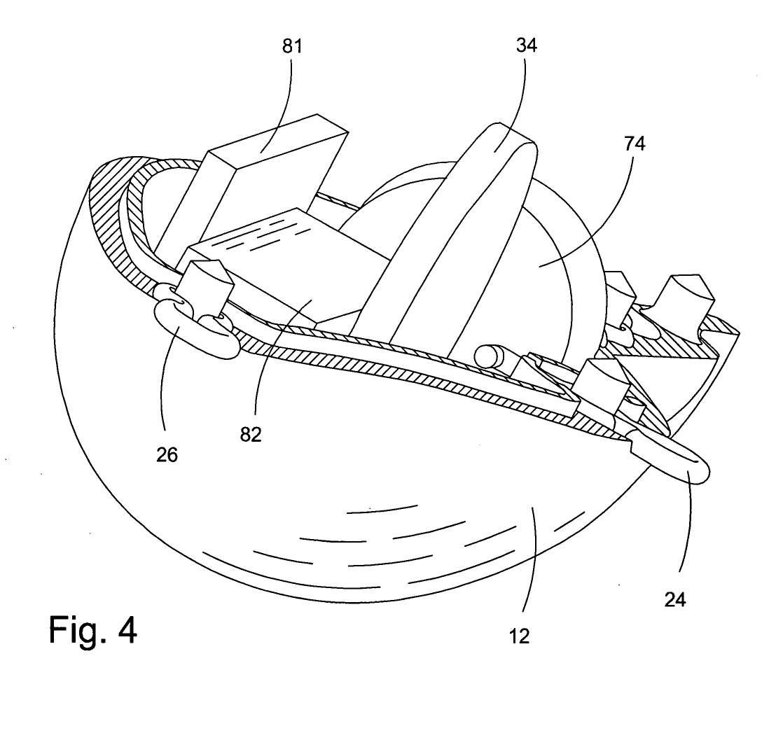

FIG. 4 is a cross-section view of the lure in FIG. 1, taken along lines 4-4. The following should be viewed in light of FIGS. 1 through 4. In some aspects, lure 10 includes one or more printed circuit boards (PCBs), located within housing 12 and used for mounting and interconnecting components of lure 10. For example, in FIG. 4, microcontroller 70 and circuit 76 (not shown) are mounted on PCB 81 and LEDs 72 are mounted on a PCB 82. When LEDs 72 are mounted on a PCB, at least portions of housing 12 are constructed of a clear or translucent material, which allows light from LEDs 72 to pass through housing 12. However, it should be understood that other portions of housing 12 could still be constructed of an opaque material. FIG. 4 shows one particular configuration of PCBs in lure 10, however, it should be understood that the present invention is not limited to any particular number or configuration of PCBs. Using PCBs simplifies the physical configuration of lure 10, reduces the footprint of components within lure 10, and simplifies fabrication operations for lure 10. As a result, time and costs for manufacturing lure 10 are reduced. As well, the use of PCBs increases the reliability of lure 10. For example, PCBs reduce the amount of wiring required between components in lure 10, thus reducing wiring connections, which can be a source of failure in devices, such as lure 10, employing electronic and/or electric components.

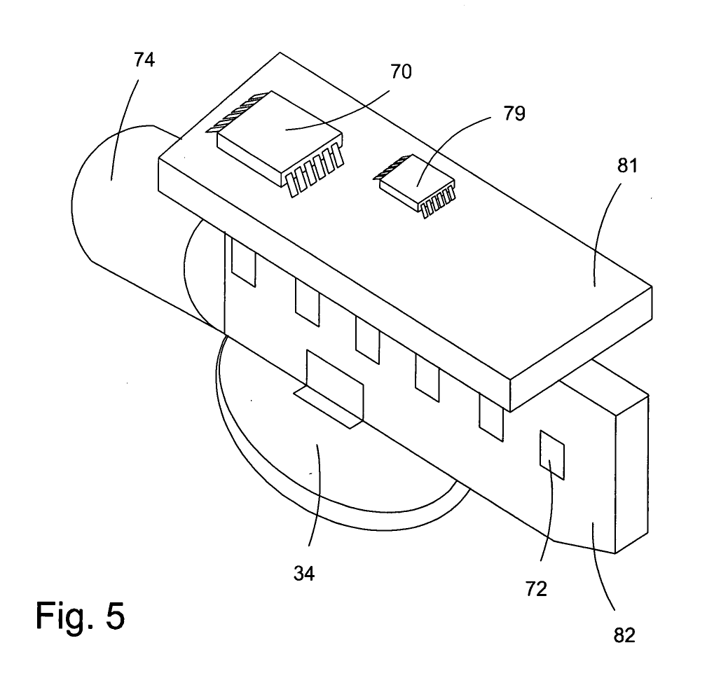

FIG. 5 is a pictorial representation of the PCBs shown in FIG. 4. FIG. 5 shows microcontroller 70 and regulator 79 on PCB 81 and LEDs 72 on PCB 82. LEDs 72 are shown on one side of PCB 82, however, it should be understood that LEDs can be located on one or both sides of PCB 82. FIG. 5 shows one possible configuration of components in lure 10. It should be understood that other configurations are included within the spirit and scope of the invention as claimed. It also should be understood that FIG. 5 is not intended to show all the components mounted on PCBs 81 and 82.

Returning to FIG. 3, one particular configuration of LEDs 72 is shown in FIG. 3, however, it should be understood that other configurations of LEDs are possible and that such configurations are included in the spirit and scope of the claimed invention. LEDs are responsive to the direction of input current. Using this characteristic, some LEDs in FIG. 3 are wired to operate in pairs, for example, D1 and D8. However, one LED 72, D22, is wired to operate singly. Further details regarding control of LEDs 72 are provided below.

As noted supra, to present the most attractive visual enticement for a game fish, it is desirable to increase the number of lights used in a lure. However, simultaneously activating a large number of lights increases instantaneous current draw on the battery, which has a limited charge. Unfortunately, battery life and performance decrease in proportion to the instantaneous current draw on a battery. Therefore, to increase the sensory output of lure 10, while minimizing instantaneous current draw on a battery 34, lure 10 uses a unique scheme for limiting the number of sensory output devices active at any one point in time. In the aspect shown in FIG. 3, to control LEDs 72 and buzzer 74, pin 7 of microcontroller 70 toggles between a high and a low state on line 84. That is, pin 7 alternates between ground potential and a voltage required to activate the LEDs and buzzer. In a coordinated fashion, pins 2, 3, 5, and 6 toggle between the same high and low states on lines 85 through 88, respectively. For example, line 84 goes low, line 85 goes high, and lines 86, 87, and 88 go low. Then, D1 and D8 are activated, since these diodes are oriented to conduct current from pin 6 to pin 7. On the other hand, D2 and D9 are oriented to block current from pin 6 to pin 7 and are not activated. The remaining diodes and the buzzer are not activated since no current is flowing from pins 3, 5, or 6. As another example, line 84 goes high, line 85 goes low, and lines 86, 87, and 88 go high. Then, D2 and D9 are activated. The remaining diodes and the buzzer are not activated since the voltage potential at each terminal of the remaining diodes is equal. In like manner, lines 84 through 88 toggle between high and low states to activate the remaining LEDs and buzzer.

As shown above, the toggling of pins 2, 3, 5-7 can be controlled so that only one pair of diodes or the buzzer is activated at any point in time. This addresses the concerns regarding the magnitude of the instantaneous current draw on the battery. That is, instantaneous current draw is limited to the draw associated with one pair of diodes or the buzzer. However, blinking LEDs or an intermittently operating buzzer may not provide the desired sensory output to attract game fish. Therefore, the microcontroller is programmed to toggle pins 2, 3, 5-7 at a frequency high enough so that the resulting flicker of LEDs 72 is not discernable to the naked eye. That is, the LEDs appear to be continuously illuminated. To present a “continuous” light, an LED is typically toggled at a frequency of at least 30 hertz. However, it should be understood that other frequencies can be used, and such modifications are within the spirit and scope of the invention as claimed. In a similar manner, buzzer 74 can be toggled to produce a “continuous” audio signal.

The present invention includes a wide variety of control sequences for the LEDs and buzzers and is not limited to any particular control sequence for the LEDs and buzzers. For example, pins 2, 3, 5-7 can be controlled to produce visible flickering or blinking of some or all of the LEDs. The LEDs can be made to blink in different patterns composed of variable numbers of LEDs. For example, the LEDs can be activated to present a “ripple” of light. The patterns can be periodic in nature or pseudo-random. In those aspects with variable voltage LEDs, control programs can vary the voltage to the LEDs to produce particular colors and color patterns. Programs specifically designed to produce lighting and audio patterns for particular game fish can be factory-loaded in microcontroller 70 or downloaded through USB port 66.

In some aspects, lure 10 includes one or more secondary inductor USB ports as described for FIG. 2. In FIG. 3, secondary inductor USB port 68 is configured to provide power to circuit 76 on lines 89 and 90 and serial data input to microcontroller 70 on lines 92 and 93. As described supra, lines 92 and 93 can be used to download control programs, for example, programs specifically designed to produce lighting and audio patterns for particular game fish.

The present invention is not limited to any particular number or configuration of LEDs. In some aspects (not shown), LEDs are attached to the interior surface of the housing (reference indicator 12 in FIG. 1). In some aspects, for example, as described for FIGS. 4 and 5, LEDs are mounted on a PCB. In a same lure (not shown), one or more LEDs can be attached to the housing and one or more other LEDs can be mounted on PCBs. The present invention also is not limited to any particular type of light source. For example, some aspects (not shown) use LED-driven light cables, that is, LEDs packaged in long medical grade tubes. In FIG. 5, the LEDs are in a linear configuration. However, in some aspects (not shown), smaller LEDs, for example, 0603 size, are configured in groups within the housing to cover all or most of the surface area of a present invention lure to accomplish inverse camouflage, characteristic of some popular bait, such as calamari or small squid. LEDs can also be placed onto platforms (not shown) on the surface (reference designator 16 in FIG. 1) of lure 10 to simulate the color-changing eyes characteristic of an artificial shrimp lure.

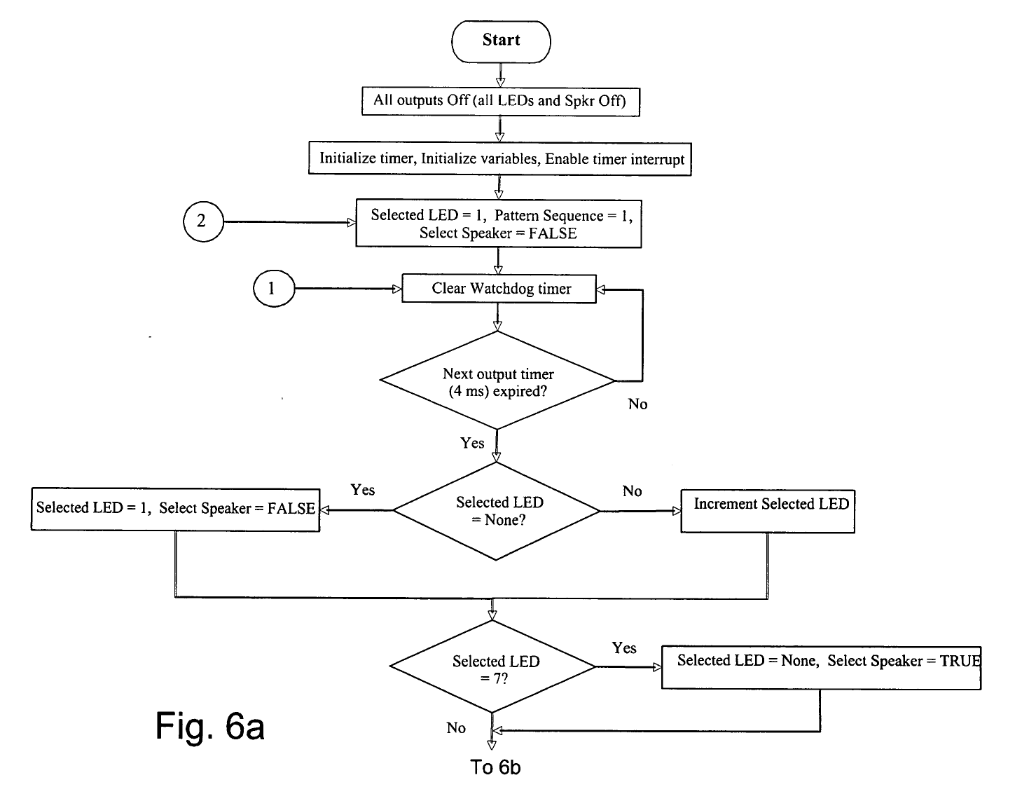

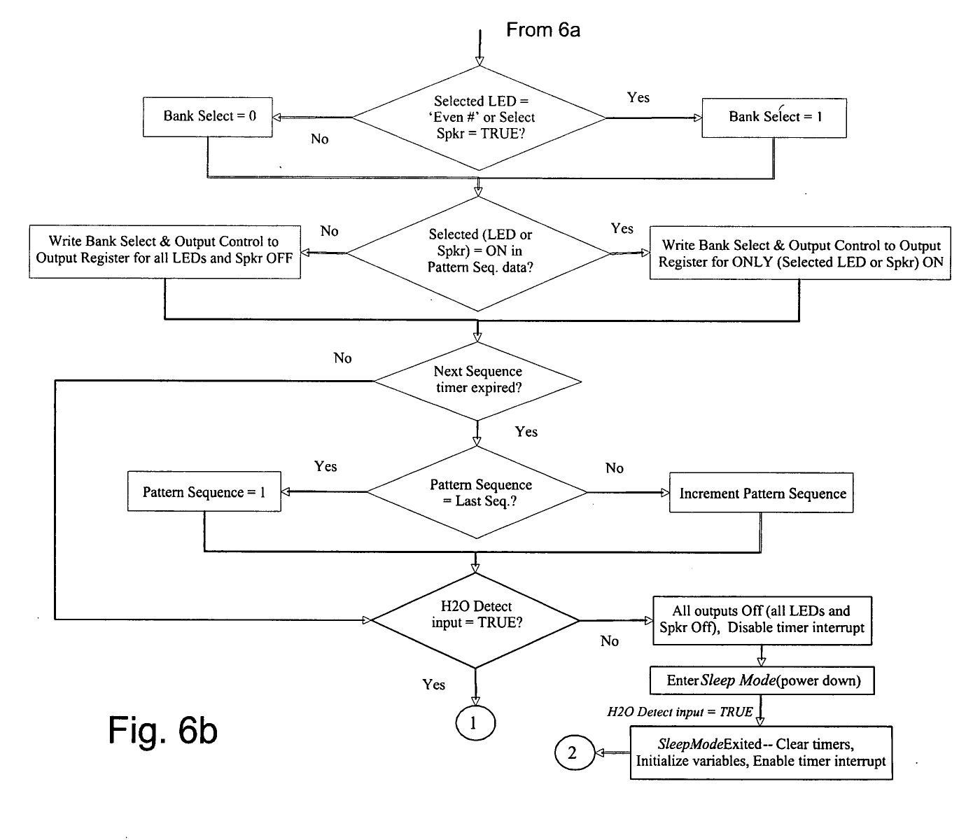

FIGS. 6a and 6b are programming flow charts for a present invention apparatus or method. FIGS. 6a and 6b illustrate the basic framework, flow, decision-making, and logic of the present invention firmware stored in memory element 60.

Thus, it is seen that the objects of the present invention are efficiently obtained, although modifications and changes to the invention should be readily apparent to those having ordinary skill in the art, which modifications are intended to be within the spirit and scope of the invention as claimed. It also is understood that the foregoing description is illustrative of the present invention and should not be considered as limiting. Therefore, other aspects of the present invention are possible without departing from the spirit and scope of the present invention.

What is claimed is:

1. An electronic fishing lure, comprising:
an electronic control element; and,
a rechargeable power element with a rechargeable battery cell.

2. The electronic fishing lure recited in claim 1 wherein said electronic control element is a first programmable microcontroller.

3. The electronic fishing lure recited in claim 2 wherein said first programmable microcontroller further comprises an arithmetic logic unit (ALU).

4. The electronic fishing lure recited in claim 1 further comprising:
a memory element.

5. The electronic fishing lure recited in claim 4 wherein said memory element further comprises a first non-volatile memory element and a first volatile memory element.

6. The electronic fishing lure recited in claim 4 further comprising:
a first secondary inductor universal serial bus (USB) port; and,
wherein said first secondary inductor USB port is connected to said memory element and is operatively arranged to accept downloads, from a device located external to said fishing lure, for storage in said memory element.

7. The electronic fishing lure recited in claim 4 wherein said electronic control element further comprises a second programmable microcontroller; and,
wherein said memory element is integral to said second programmable microcontroller and further comprises a second non-volatile memory element and a second volatile memory element.

8. The electronic fishing lure recited in claim 7 wherein said second volatile memory is a Read/Write memory (RAM) element and said second non-volatile memory element is a read-only memory (ROM) element selected from the group including erasable ROM (EPROM) elements, electrically erasable ROM (EEPROM) elements, and FLASH memory elements.

9. The electronic fishing lure recited in claim 7 further comprising:
a second secondary inductor USB port; and,
wherein said second secondary inductor USB port is connected to said second microcontroller and is operatively arranged to accept downloads, from a device located external to said fishing lure, for storage in said memory element.

10. The electronic fishing lure recited in claim 1 wherein said power-recharging element further comprises constant voltage, constant current recharge circuitry.

11. The electronic fishing lure recited in claim 10 wherein said constant voltage, constant current circuitry is operatively arranged to voltage in a range of approximately 3.4V to approximately 60V.

12. The electronic fishing lure recited in claim 1 wherein said rechargeable battery cell is a lithium-ion battery cell.

13. The electronic fishing lure recited in claim 1 further comprising:
an first external surface; and,
wherein said power-recharging element further comprises first and second recharge contact points, disposed on said first external surface and operatively arranged for connection to a power supply located external to said fishing lure.

14. The electronic fishing lure recited in claim 1 further comprising:
a third secondary inductor USB port; and,
wherein said third secondary inductor USB port is connected to said power-recharging element and is operatively arranged to accept recharging power from a power source located external to said fishing lure.

15. The electronic fishing lure recited in claim 1 further comprising:
a second external surface and switch circuitry with first and second switch points disposed on said second external surface and connected to said electronic control element; and,
wherein said switch circuitry is operatively arranged to control said electronic control element.

16. The electronic fishing lure recited in claim 15 wherein said electronic control element is a third programmable microcontroller and said switch circuitry is operatively arranged to toggle said third programmable microcontroller between an active mode and a standby mode, responsive to a change in an electrical resistance in said switch circuitry.

17. The electronic fishing lure recited in claim 15 wherein said switch circuitry is digital.

18. The electronic fishing lure recited in claim 7 further comprising:
a light and an audio output device connected to said second microcontroller;
wherein said second non-volatile memory element has a first control program in storage; and,
wherein said second microcontroller is operatively arranged to control said light and said audio output device responsive to said first control program.

19. The electronic fishing lure recited in claim 18 wherein said second microcontroller is operatively arranged, responsive to said first control program, to activate said light and deactivate said audio output device for a first period of time and deactivate said light and activate said audio output device for a second period of time, where said first and second periods of time do not overlap.

20. The electronic fishing lure recited in claim 19 further comprising:
a multiplexing element operatively connected to said second programmable microcontroller, said light, and said audio output device.

21. The electronic fishing lure recited in claim 20 wherein said multiplexing element is integral to said microcontroller.

22. The electronic fishing lure recited in claim 7 further comprising:
an audio output device connected to said second microcontroller;
wherein said second non-volatile memory element has a second control program in storage; and,
wherein said second microcontroller is operatively arranged to control said audio output device responsive to said second program.

23. The electronic fishing lure recited in claim 22 wherein said audio output device is selected from the group including speakers and buzzers.

24. The electronic fishing lure recited in claim 22 further comprising:
a first printed circuit board (PCB); and,
wherein said at least one light is disposed upon said first PCB.

25. The electronic fishing lure recited in claim 7 further comprising:
at least one light connected to said second microcontroller;
wherein said second non-volatile memory element has a third control program in storage; and,
wherein said second microcontroller is operatively arranged to control said at least one light responsive to said third program.

26. The electronic fishing lure recited in claim 25 wherein said at least one light further comprises a plurality of lights; and,
wherein said second microcontroller is operatively arranged, responsive to said third control program, to activate each light in said plurality of lights for a respective period of time, where each said respective period of time does not overlap any other said respective period of time.

27. The electronic fishing lure recited in claim 26 wherein said plurality of lights further comprises a plurality of pairs of lights; and,
wherein said second microcontroller is operatively arranged, responsive to said third control program, to activate each pair of lights in said plurality of pairs of lights for a respective period of time, where each said respective period of time does not overlap any other said respective period of time.

28. The electronic fishing lure recited in claim 25 wherein said at least one light is a light-emitting diode (LED).

29. The electronic fishing lure recited in claim 28 wherein said LED is a variable voltage LED; and,
wherein said second microcontroller is operatively arranged, responsive to said third control program, to provide a plurality of different voltages to said variable voltage LED.

30. The electronic fishing lure recited in claim 25 further comprising:
a second PCB; and,
wherein said at least one light is disposed upon said second PCB.

31. The electronic fishing lure recited in claim 2 wherein said first microcontroller is a complimentary metal oxide semiconductor (CMOS) device.

32. The electronic fishing lure recited in claim 1 wherein said electronic control element is selected from the group including timer circuits, oscillator circuits, and solid-state components.

33. The electronic fishing lure recited in claim 1 further comprising a third PCB; and,
wherein said electronic control element is disposed upon said third PCB.

34. The electronic fishing lure recited in claim 1 further comprising a fourth PCB; and,
wherein said rechargeable power element is disposed upon said fourth PCB.

35. An electronic fishing lure, comprising:
a rechargeable battery; and,
a constant voltage, constant current recharging circuit.

36. An electronic fishing lure, comprising:
a programmable microcontroller comprising a non-volatile memory element, a volatile memory element, and an arithmetic logic unit; and,
a sensory output element operatively connected to said microcontroller.

37. An electronic fishing lure, comprising:
a memory element; and,
a secondary inductor/universal serial bus port operatively connected to said memory element.

38. An electronic fishing lure, comprising:
a power-recharging element; and,
a secondary inductor/universal serial bus port disposed on an external surface of said fishing lure and operatively connected to said power-recharging element.

39. A method for attracting fish, comprising:
controlling a light and a sound device in a fishing lure using an on-board programmable microcontroller with an arithmetic logic unit, a non-volatile memory element, and a volatile memory element;
storing programs for controlling said light and said sound device in said non-volatile memory element;
powering said fishing lure with an on-board rechargeable battery cell; and,
recharging said battery cell using an on-board rechargeable power element.

40. The method for attracting fish as recited in claim 39 further comprising:
disposing a first secondary inductor universal serial bus (USB) port in said lure and connecting said first secondary inductor USB port to said programmable microcontroller; and,
accepting control program downloads in said first secondary inductor USB port for storage in said non-volatile memory element.

41. The method for attracting fish as recited in claim 39 wherein said power-recharging element comprises constant voltage, constant current recharge circuitry and said rechargeable battery cell is a lithium-ion battery cell.

42. The method for attracting fish as recited in claim 39 wherein said lure further comprises a first external surface; and,
said method further comprising:
disposing first and second recharge contact points on said first external surface and connecting said power-recharging element to said first and second recharge contact points.

43. The method for attracting fish as recited in claim 39 further comprising:
disposing a second secondary inductor USB port in said lure and connecting said second secondary inductor USB port to said power-recharging element.

44. The method for attracting fish as recited in claim 39 wherein said lure further comprises a second external surface and digital switch circuitry; and,
said method further comprising:
disposing first and second switch points on said second external surface and connecting said first and second switch points to said programmable microcontroller; and,
toggling said programmable microcontroller between an active mode and a standby mode, responsive to a change in an electrical resistance in said switch circuitry.

45. The method for attracting fish as recited in claim 39 wherein controlling a light and an sound device further comprises activating said light and deactivating said sound device for a first period of time and deactivating said light and activating said sound device for a second period of time, where said first and second periods of time do not overlap.

46. The method for attracting fish as recited in claim 39 wherein said fishing lure further comprises a plurality of lights; and,
said method further comprising:
said microcontroller activating each light in said plurality of lights for a respective period of time, where each said respective period of time does not overlap any other said respective period of time, wherein said activating is in response to said program.

47. The electronic fishing lure recited in claim 39 wherein said light is a light-emitting diode (LED).

48. The electronic fishing lure recited in claim 39 further comprising:
a first printed circuit board (PCB); and,
said method further comprising: disposing said light upon said first PCB.

49. The electronic fishing lure recited in claim 39 further comprising:
a second PCB; and,
said method further comprising: disposing said programmable microcontroller and said rechargeable power element upon said second PCB.
